(19) United States
(12) Patent Application Publication
(10) Pub. No.: US 2005/0063412 A1
(43) Pub. Date: Mar. 24, 2005

(54) Data communication facilitating

(76) Inventor: Adnan Osmani, Westmeath (IE)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 10/942,665

(22) Filed: Sep. 15, 2004

Related U.S. Application Data
(60) Provisional application No. 60/504,139, filed on Sep. 19, 2003.

(51) Int. Cl. H04B 7/212

(52) U.S. Cl. 370/442

(57) ABSTRACT

An apparatus for retrieving information via a communication network is configured to analyze a first request for a collection of information, produce a set of second requests for a corresponding set of portions of the collection of information, each of the set of second requests being associated with a separate communication socket, store received segments of data associated with each of the communication sockets such that segments of data corresponding to a particular socket are stored in association with other of the received segments of data, and reconstitute the collection of information from the stored segments of data. Other aspects of the disclosure include: encoding and decoding files by replacing tags with smaller codes and vice versa, converting information into audio segments and increasing the pitch of the segments (and vice versa), encrypting and decrypting data, and providing users control over operation of a network interface.

### CROSS-REFERENCE TO RELATED ACTIONS

This application claims the benefit of U.S. Provisional Application No. 60/504,139 filed Sep. 19, 2003.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Computer network information access and transfer is widely used today, especially over the Internet. The world has progressed greatly since the humble beginnings of mass Internet access using 14.4 k modems. Since then, 28.8 k modems and 56.6 k modems have been developed, and more recently broadband Internet access has been introduced and is now widely used. The demand for more information at greater download/access speeds has driven this development of higher-capacity, faster communication lines and modems.

Some computer applications have been developed to help improve information download rates over computer networks. These applications achieve improved rates using multiple simultaneous data connections allowing multiple, parallel downloads to a given computer. Such applications use multiple connections to avoid bandwidth limits and restrictions of single lines, and to avoid bottlenecks typically encountered when using a single line for data access/download.

To help improve data transfer speeds, data may be compressed. There are various techniques in use today to reduce the amount of data transferred over computer networks. Data may be compressed before transfer and decompressed after transfer such that the data are transferred while sending a reduced-data set over the network to reduce network traffic to improve network performance generally and transfer less data per transfer for better transfer speed on an individual basis.

Sending data over a publicly-accessible computer network also raises security and privacy concerns. Sensitive information (for business, personal, or other reasons) may need to be transferred over a computer network. This information may be encrypted to help ensure that any unintended recipients (whether they be accidental recipients, persons that illegally intercept communications, etc.) cannot decipher the information that they receive, or at least not easily so.

### SUMMARY

In general, in an aspect, the invention provides an apparatus for retrieving information via a communication network, the apparatus being configured to analyze a first request for a collection of information, produce a set of second requests for a corresponding set of portions of the collection of information, each of the set of second requests being associated with a separate communication socket, store received segments of data associated with each of the communication sockets such that segments of data corresponding to a particular socket are stored in association with other of the received segments of data, and reconstitute the collection of information from the stored segments of data.

Implementations of the invention may include one or more of the following features. The communication network includes servers and the second requests are configured to be sent to different servers in the communication network. The first request is for a web page, and the second requests cause the servers to obtain data from a web server storing the web page with a higher priority than other web page requests to the web server. The requests are one of INET control commands and Xsocket commands. The set of second requests is configured to request downloading a web page and at least some of the second requests are associated with sockets typically used for data communication other than downloading web pages. The apparatus is further configured to produce a file for storing the segments of data. The apparatus is configured to store the received segments of data in separate portions of the file in accordance with the sockets with which the segments of data are associated. The apparatus is further configured to establish LAN connection with a server in the computer network from which to receive the segments of data. The apparatus comprises a computer program product residing on a computer readable medium and including computer-readable instructions for causing a computer to analyze the first request, produce the set of second requests, stored received data segments, and reconstitute the collection of information. The apparatus is further configured to effect registry updates to alter designated purposes of communication sockets.

Implementations of the invention may also include one or more of the following features. The collection of information is a web page in one of HTML and XML format, the apparatus being further configured to replace at least one uncommon character string in the reconstituted web page with a corresponding HTML or XML tag. Each of the uncommon character string comprises less data than the corresponding HTML or XML tag. At least one of the at least one uncommon character string is a single character.

In general, in another aspect, the invention provides a time-division-multiplexed data structure comprising data slots for containing data, where the data slots are designated for containing data in accordance with a standard protocol for communicating with a computer terminal through a serial port of the computer terminal, and where at least one of the data slots that, according to the protocol, should contain data, if any, for information other than a web page, is populated with data of a web page.

Implementations of the invention may include one or more of the following features. Multiple data slots that, according to the protocol, should contain data, if any, for information other than a web page, are populated with data of a web page. The web page is divided into divisions equal in number to a quantity of the multiple data slots, and wherein the multiple data slots are each populated with data from a corresponding one of the divisions of the web page. A majority of data slots of the data structure are designated for containing data in accordance with the standard protocol. A quantity of the data slots is between two and seven, inclusive.

In general, in another aspect, the invention provides a device for encoding non-audio data into compressed audio data, the device being configured to replace portions of the non-audio data with audio segments such that portions of the non-audio data that are different will be replaced with different frequencies of audio segments, and increase at least one pitch of the audio segments.

Implementations of the invention may include one or more of the following features. The device is configured to increase the at least one pitch using hardware. The hardware is a Microsoft® media control interface. The device is configured to increase the at least one pitch using software to remove portions of information forming the audio segments. The device is configured to increase the at least one pitch for all of the audio segments by a common amount. The device is configured to increase the at least one pitch of the audio segments multiple times. The device is configured to increase the at least one pitch of the audio segments until a limit is reached. The limit is a file size such that the audio segments form a file with a duration between about 0.4 seconds and about 0.5 seconds. Lengths of the audio segments are dependent upon an amount of the non-audio data. The portions of the non-audio data are characters and wherein each unique character has an associated unique audio segment frequency. The device is further configured to send the audio segments with increased pitch to a communication network. The device is configured to stream the audio segments with increased pitch to the communication network. The device comprises a computer program product residing on a computer readable medium and including computer-readable instructions for causing a computer to replace the non-audio data with audio segments and to increase the at least one pitch of the audio segments.

In general, in another aspect, the invention provides a device for decoding compressed audio data into non-audio data, the device being configured to decrease at least one pitch of received, pitch-elevated audio segments to convert the pitch-elevated audio segments into desired-pitch audio segments, and replace the desired-pitch audio segments with associated non-audio data portions such that desired-pitch audio segments of different frequencies will be replaced with different non-audio data portions.

Implementations of the invention may include one or more of the following features. The device is configured to decrease the at least one pitch using hardware. The hardware is a Microsoft® media control interface. The device is configured to decrease the at least one pitch using software to add portions of information to the audio segments. The device is configured to decrease the at least one pitch of the audio segments multiple times. The device is configured to decrease the at least one pitch of the audio segments until the audio segments have at least one desired pitch. The portions of the non-audio data are characters and wherein each unique character has an associated unique audio segment frequency. The device is further configured to receive the pitch-elevated audio segments from a communication network. The device is configured receive the pitch-elevated audio segments from the communication network in a streaming format. The device is further configured to have the streaming pitch-elevated audio segments played by speakers and recorded before the at least one pitch is decreased. The device comprises a computer program product residing on a computer readable medium and including computer-readable instructions for causing a computer to decrease the at least one pitch of received, pitch-elevated audio segments and to replace the desired-pitch audio segments with associated non-audio data portions.

In general, in another aspect, the invention provides a computer program product residing on a computer readable medium and comprising computer-readable instructions for causing a computer to produce a socket connection to a communication network, send web page requests toward the communication network, and convert HTML web page data received from the communication network into RichEdit format.

Implementations of the invention may include one or more of the following features. The computer-readable instructions comprise a RichEdit control. The computer-readable instructions are contained in a header file. The computer program product resides in a computer that contains Microsoft® Internet Explorer and wherein the web page requests are sent independent of Microsoft® Internet Explorer. The HTML web page data are converted by setting a RichEdit control color to at least approximate a background color of a received HTML web page, converting HTML links to blue, underlined, selectable text, and converting other text to a font and style that at least approximates the text font and style of the HTML page. The HTML web page data are converted by streaming images in the HTML web page into a buffer and loading them using at least one of jpeg and gif headers.

In general, in another aspect, the invention provides a method of encrypting data, the method comprising replacing characters in a data set with corresponding strings of data, a different character string corresponding to each different character, multiplying the strings of data by a predetermined common multiplier, and multiplying the strings of data by a user multiplier, where the user multiplier is provided by a user such that a product of the strings of data, the common multiplier, and the user multiplier is substantially unique to the user.

Implementations of the invention may include one or more of the following features. The corresponding strings of data are 600-character strings unique to each character in a set of characters. The common multiplier is a concatenated portion of pi. The common multiplier is pi taken to six decimal places. The user multiplier is entered into a computer by the user through at least one of a keyboard and a mouse.

In accordance with implementations of the disclosure, one or more of the following capabilities may be provided. Data download rates for computer network downloads can be increased compared to current techniques. Data can be downloaded from computer networks using a web browser at speeds of about 5 times or more faster than with current web browsers without changing/adding hardware. Data can be transferred electronically much more quickly than with current techniques. A file of information can be compressed into a short duration of time-based data for transfer over a communication network. Files, e.g., HTML files, can be compressed into smaller amounts of data. A web browser can be provided inside a header file. A web browser can be provided that provides increased control over the browser relative to present browsers, e.g., increased control of data flow through the browser relative to present browsers. A web browser can be provided that downloads information faster than present web browsers. An application that is part of the web browser suite can download information faster than with current techniques. Data can be transferred in a compressed audio form as opposed to current methods of standard transfer. Data transfer techniques can be provided that are compatible with other web browsers currently available.

These and other capabilities will be more fully understood after a review of the following figures, detailed description, and claims.

### BRIEF DESCRIPTION OF THE FIGURES

FIG. 1 is a simplified block diagram of a communication system including servers, a communication network, and a computer terminal.

FIG. 2 is a block diagram of modules contained in memory of the computer terminal shown in FIG. 1.

FIG. 3 is a simplified diagram of a typical TCP/IP TDM frame.

FIG. 4 is a block flow diagram of a process for downloading information using the system shown in FIG. 1.

FIG. 5 is a simplified diagram of a blank file in the computer terminal shown in FIG. 1 for storing downloaded information.

FIG. 6 is a block flow diagram of a process of encoding, sending, receiving, and decoding data.

FIG. 7 is a simplified diagram of a look-up table that provides relationships between characters and corresponding audio frequencies.

FIG. 8 is a block flow diagram of a process of compressing, sending, and de-compressing files.

FIG. 9 is a simplified diagram of a look-up table of common HTML tags 132 and corresponding replacement strings.

FIG. 10 is a block flow diagram of a process of requesting and downloading web pages.

FIG. 11 is a simplified diagram of a table of ASCII characters and corresponding 600-letter strings.

FIG. 12 is a block flow diagram of a process of encrypting a file of data.

FIG. 13 is a screenshot of a web browser that includes a DVD player.

### DETAILED DESCRIPTION OF PREFERRED EMBODIMENTS

The following describes various techniques for interacting with a computer network. For example, a computer network interface, e.g., a web browser, can use multiple socket connections to obtain information from a source. The source is queried for information and instructed to supply different parts of the information to different sockets. The information received by the different sockets is assembled by the browser into the requested data. Further, the network interface can decode files, such as HTML files, that have been downloaded and that have had markup tags replaced with smaller codes for the markup tags. The interface can also convert information into audio segments, increase the pitch of the audio segments to produce increased-pitch information, transfer the increased-pitch information, receive increased-pitch information, reduce the pitch of the increased-pitch information to produce pitch-reduced audio, and convert the pitch-reduced audio to corresponding information. The interface can also encrypt data, possibly using a selection of techniques. The interface is preferably configured to allow user control over the operation of the interface. This interface is exemplary, however, and not limiting of the disclosure as other implementations in accordance with the disclosure are possible.

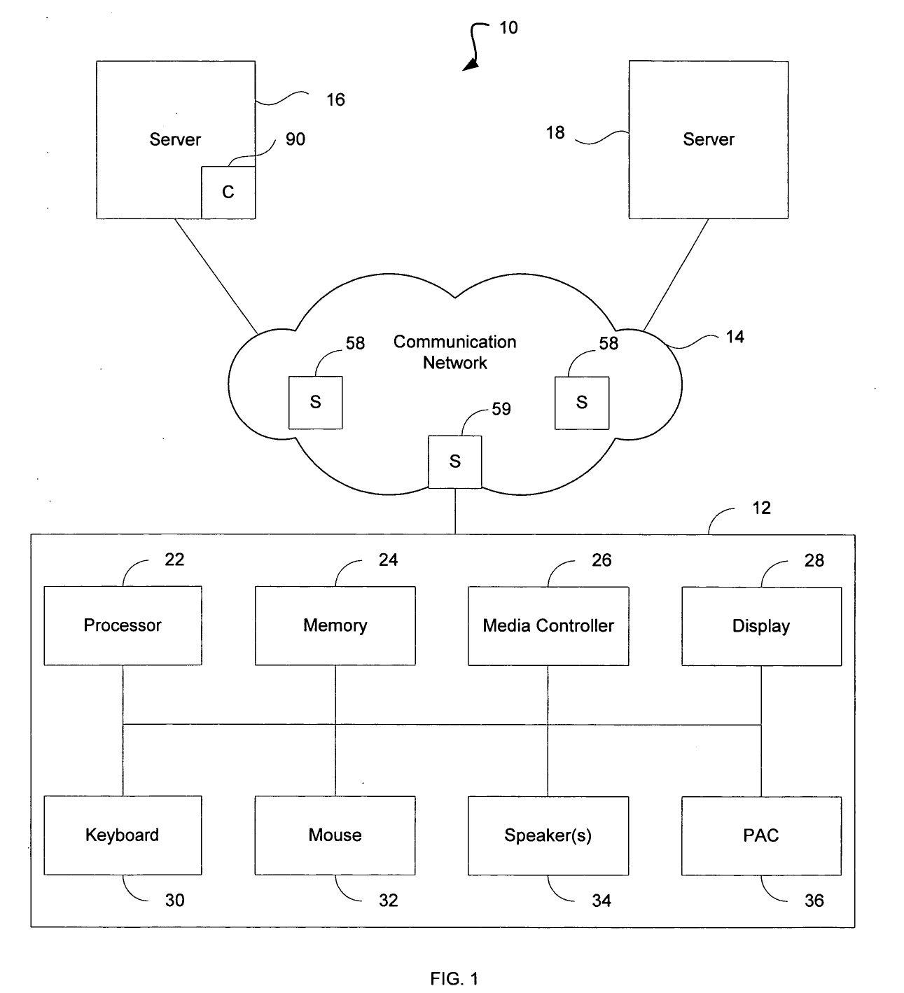

Referring to FIG. 1, a communication system 10 includes a computer system 12, a communication network 14, and servers 16, 18. While two servers 16, 18 are shown, other quantities of servers are possible. The servers 16, 18 are configured to provide data, e.g., web pages, audio files, etc., to the computer system 12 via the network 14. The network 14 is a computer network for transferring data, such as the Internet or a local area network (LAN). The system 10 is configured for transferring data between the servers 16, 18 and the computer system 12 over the network 14. For example, files can be sent from the system 12 to the server 16, web pages can be downloaded from the servers 16, 18 to the system 12, etc.

The computer system 12 includes a processor 22, memory 24, a media controller 26, a display 28, a keyboard 30, a mouse 32, speakers 34, and a pitch-altering circuit (PAC) 36. The processor 22 can be a personal computer central processing unit (CPU) such as those made by Intel® Corporation. The memory 24 includes cache, random access memory (RAM), read-only memory (ROM), and one or more disk drives such as a hard-disk drive, a floppy-disk drive, a CD-ROM drive, and/or a zip drive, etc. The media controller is configured to manipulate The display 28 is a cathode-ray tube (CRT), although other forms of displays are acceptable, e.g., liquid-crystal displays (LCD) including TFT displays. The keyboard 30 and mouse 32 provide data input mechanisms for a user (not shown). The speakers 34 can produce audio output for the user. The PAC 36 is configured to alter pitch of audio input to the PAC 36, and may be able to perform other functions. The PAC 36 may be, for example, a Microsoft® media control interface. The components 22, 24, 26, 28, 30, 32, 34, and 36 are connected by a bus 38. The computer system 12 can store, e.g., in the memory 24, software code containing instructions for controlling the processor 22 to perform functions described below, collectively included in technology referred to as XWEBS™, e.g., to implement a web browser. Portions of exemplary code are also provided below.

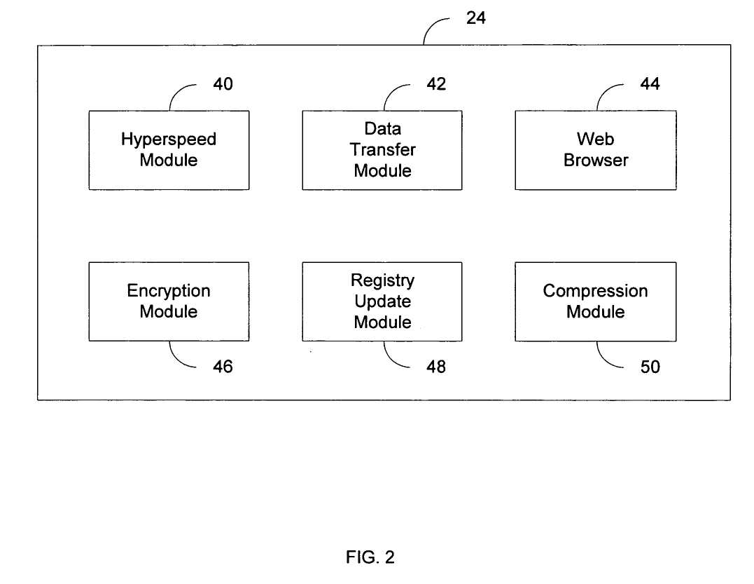

Referring also to FIG. 2, the memory 24 includes software code that includes a hyperspeed module 40, a data transfer module 42 (named Icarus™), a web browser module 44 (named Pandora™), an encryption module 46 (named Xure™), a registry update module 48, and a compression module 50 (named DivAO™). These modules contain instructions for implementation by the processor 22.to perform various new techniques as described below.

Hyperspeed

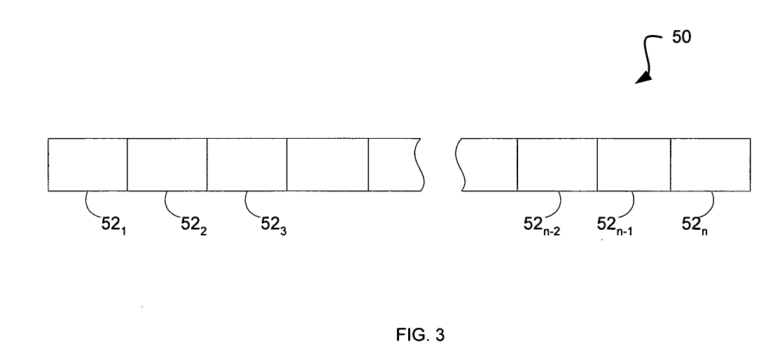

The hyperspeed module 40 is configured to quickly download information from the servers 16, 18 to the computer system 12. The module 40 can allocate sockets associated with the computer system 12 and can issue INET controls, as well as listen, get, and retrieve commands for use in interacting with a communication connection to the network 14. Referring also to FIG. 3, a typical TCP/IP TDM frame 50 includes numerous segments 52 each associated with a port number. These port numbers, combined with an IP address of the computer system 12 and data to be transferred comprise sockets. Typically, even though the segments 52 are allocated for specific purposes, many of the segments 52 go unused. The module 40, in accordance with instructions as to the number of sockets desired for data download received from the user through the keyboard 30 and/or mouse 32 (or other user input), re-allocates some of the segments 52. For example, if the user selects seven as the number of sockets to use, then the module 40 re-allocates six of the segments 52 (because one segment 52 was already allocated for data download) for data download. Preferably, the module 40 re-allocates segments that are typically general purpose segments that are programmed for desired functionality. Allocation may take various forms: (1) the selection of unused sockets, (2) the selection of unused ports, (3) the data binding of an Internet transfer session to a selected port or socket. The module 40 is further configured to issue OpenURL, listen, get, and retrieve commands, and to issue modified INET controls. A modified NET control is used inside a data binding loop in a structure allowing for a group of WET controls to be used to download the same piece of information. A structure, here, at a high level may be:

Void Inet_Loop( ){
Initiate(Inet1); Initiate(Inet2);
Inet1.Listen(Data.Port.1); Inet2.Listen(Data.Port.2)
}

TDM typically involves placing multiple data streams in signals by separating them into many segments. The Hyperspeed module 40 emulates this by breaking the data streams into chunks (e.g. C++-defined chunks) of data of a ratio specified by a program binding process, which locks data acquisition to a defined address on a network or internet-network. The module 40 verifies which segments of data have been, or are currently being, acquired, and initiates further data streams in the signal to increase (and possibly maximize) the potential bandwidth being used.

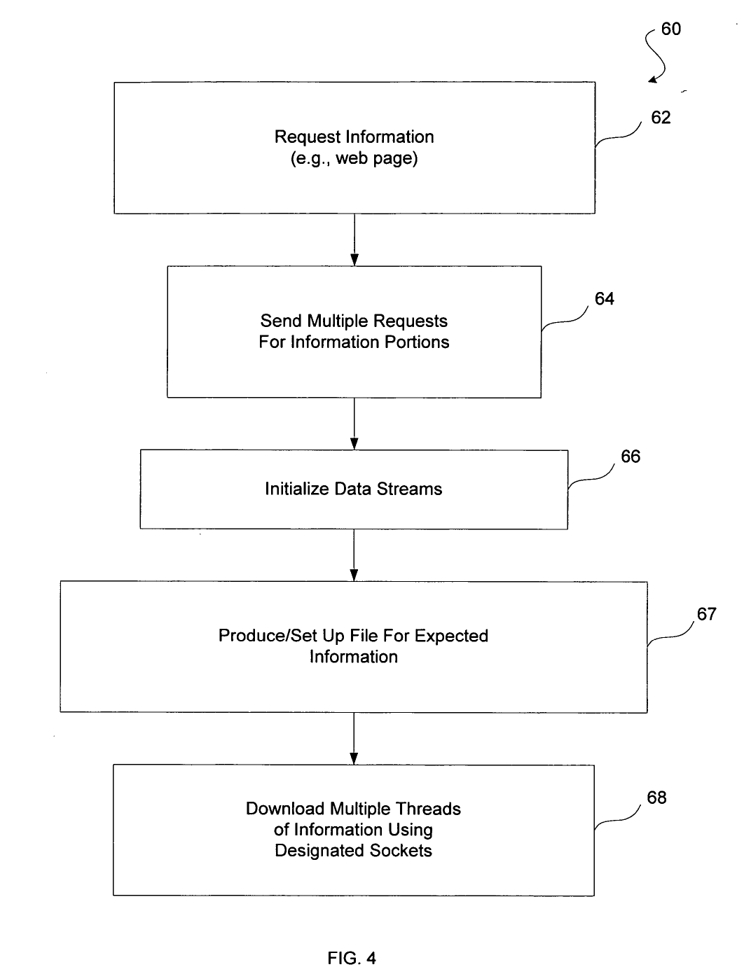

Referring also to FIG. 4, software instructions in the memory 24 and/or the disk drive(s) 26 cause the processor 22 to perform a process 60 for downloading information. The process 60, however, is exemplary only and not limiting. The process 60 may be altered, e.g., by having stages added, removed, or rearranged. Stages, or portions of stages, may be performed in orders different than as shown and described, including being performed concurrently with other stages or portions of stages. For exemplary purposes, the process 60 is described assuming that a web page is requested, although the process 60 may be applied to obtaining other information.

At stage 62, a web page is requested from a source, e.g., a web server such as the server 16. The web page is requested by a web browser, e.g., Internet Explorer®, through a standard socket connection request, e.g., a Winsock connection. The request initiates production of a log file documenting the request. The module 40 causes the processor 22 to halt the request and to analyze the log file for the request.

At stage 64, the module 40 sends multiple requests for portions of the desired web page. The module 40 may be given the number of sockets that are available for receiving the web page's information, or the module 40 may be configured to determine the number of sockets available, e.g., through a process loop that evaluates and allocates available sockets. The module 40 sends a corresponding number of INET control commands that are a configuration of INET component (Internet address to access, port to use, etc.) followed by a group of commands such as get, send, and request.

InetControl1.Listen( );

IPAddress.Bind(Data,Port,IP.Address);

InetGroup.Get(http://www.prog.com/n.exe,21,32);

Etc.

The INET control commands request portions of the web page, preferably to high-speed servers 58 via a gateway server 59 (FIG. 1). For example, if seven sockets are to be used, then the module 40 sends seven INET control commands to seven broadband servers 58 (only three shown) in the network 14. The broadband servers 58 are high-speed capable proxy servers. These proxy servers 58 can be instructed to download data to the system 12 on behalf of another server, that provides, e.g., a website. These servers 58 are instructed to download corresponding portions of the web page. For example, with seven servers 58 used, one server 58 requests the first seventh of the web page information, another server requests the second seventh of the information, etc. The servers 58 proceed to download their corresponding portions of the web page to the computer terminal 12 through the gateway 59. Included with the information being sent by each server is an indication as to which portion of the web page the associated information belongs.

At stage 66, data streams are initialized for data input/output. The module 40 sets up data streams for writing data. Data streams are established in the computer system 12 and the streams of data from the network 14 are addressed to the appropriate streams in the computer system 12 so that data are copied from the streams from the network 14 to the streams in the computer system 12.

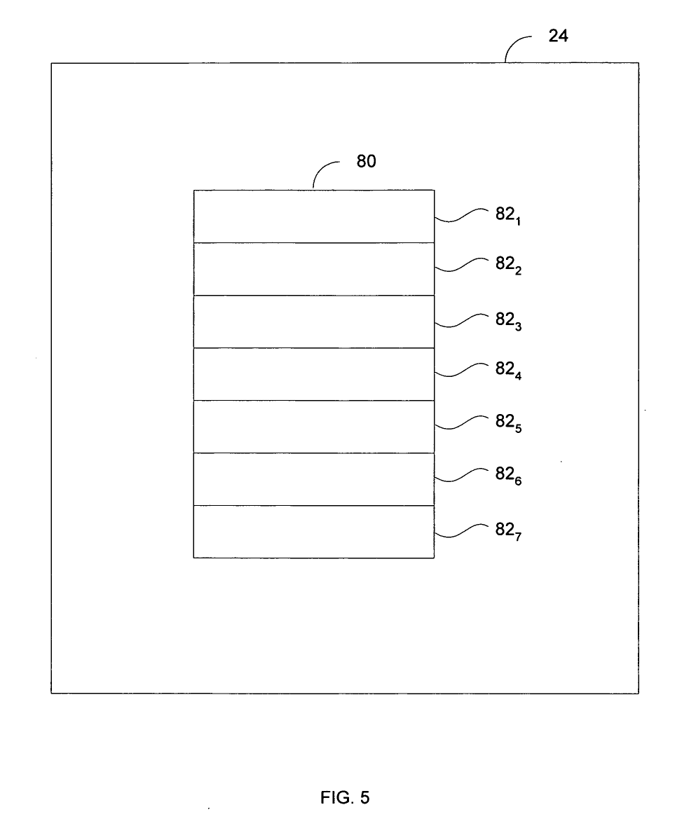

At stage 68, the module 40 causes the processor 22 to produce a file for the data to be received. Referring to FIG. 5, the module 40 produces a blank file 80, e.g., in cache, in the computer system 12 designated for the incoming web page. This serves as a place holder so that the incoming data can be quickly stored. The file is divided into portions 82 corresponding to the number of portions into which the request is split (e.g., here seven portions 82₁-82₇).

At stage 70, multiple threads of information are downloaded through the designated sockets to the computer system 12. The module 40 uses listen, get, and retrieve commands to help ensure ongoing connection/interaction for the sockets designated for the download. The commands are sent to a modem of the computer system 12 and provide for constant connection in that data, if any are available, are put into the corresponding segments of the next TDM frame. A LAN connection is formed between the edge router 59 and the computer terminal 12. Otherwise unused bandwidth corresponding to unused sockets may be used to effectively increase the realized bandwidth of the connection between the network 14 and the computer terminal 12, thus bypassing traditional bandwidth “limits.”

At stage 72, the data are received, stored, and reconstituted by the computer system 12. As the data received by the computer system 12, the data are stored in the respective portions 82 of the file 80 according to the respective server from which the data are received. Continuing the example from above with 7 servers being requested for 7 different portions of the file 80, and the file 80 being divided into 7 corresponding portions 82, the data are received and allocated and stored in the respective portions 82₁-82₇. The data are allocated to the corresponding portions 82 in accordance with, e.g., identifiers associated with the data, corresponding TDM segments in which the data are received, or other techniques for identifying and allocating the data to the corresponding segments 82. The segments may or may not fill completely with the allocated space for each of the portions 82. Once the data are done being stored into the file 80, the computer system 12 reconstitutes the files, here a web page, by concatenating the data from the respective segments 82.

The process 60 described above is exemplary only and not limiting of the invention. For example, different techniques may be used to request data to be downloaded to the computer terminal 12. For example, the request from the computer terminal 12 for a web page can be re-routed through an INET controlled instead of using a WinSock command. Alternatively, a data request can be re-routed through several INET controls instead of a single INET control. An array of INET controls may be set using a general configuration command which in pseudo code may resemble Set_INET_Arrays(Number Needed, Output Array).

Icarus

The Icarus module 42 is configured to modulate data and demodulate modulated data (i.e., includes instructions for causing modulation of data and demodulation of modulated data). The module 42 can convert data characters into corresponding frequency segments, increase (preferably uniformly) the frequencies of the segments, and transmit the increased-frequency segments. The module 42 can regulate the frequency decreasing of received frequency-increased segments, and convert the reduced frequencies into data characters. The frequencies are preferably unique to each character and are sufficiently separated in frequency to be distinguishable when analyzing the frequency segments to convert from frequencies back to characters.

The functions provided by the Icarus module 42 have broad applicability. The functions provided may be used with a variety of audio devices that support pitch shifting, and may be provided with devices employing any of a variety of operating systems. The techniques may be used in conjunction with a computer, such as a personal computer, or with other electronic devices used for transferring data. The Icarus module 42 may be tailored to a Windows application, but the Icarus techniques are applicable to other environments including systems with multimedia capabilities or a card or other device for providing such capabilities.

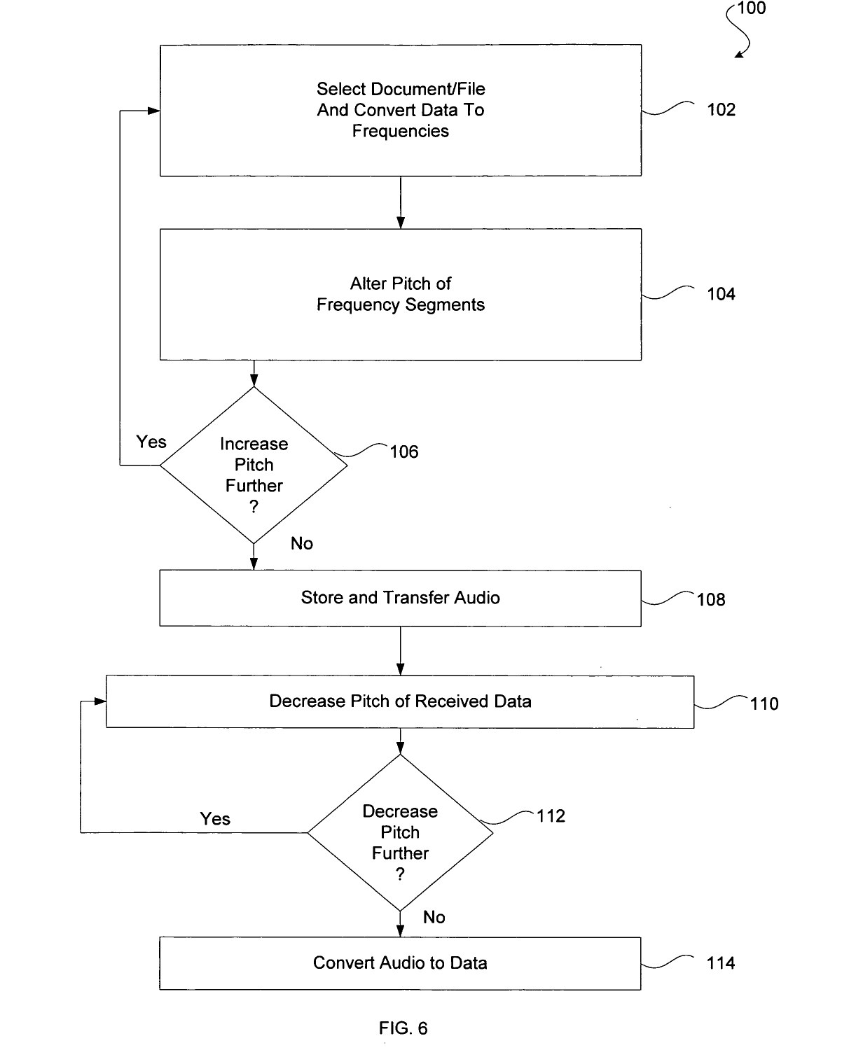

In operation, referring to FIG. 6, with further reference to FIGS. 1-2, a process 100 for encoding, sending, receiving, and decoding data using the Icarus module 42 includes the stages shown. The process 100, however, is exemplary only and not limiting. The process 100 may be altered, e.g., by having stages added, removed, or rearranged.

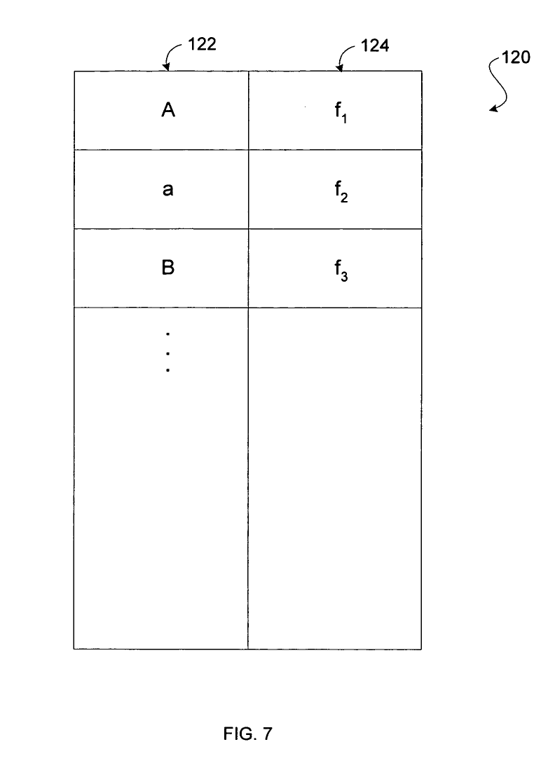

At stage 102, a document or file is selected for transmission and converted to an audio file. The user of the computer terminal 12 selects a document or file in a standard manner (e.g., attaching the document or file to an email using the mouse 32 to select the document/file). The document/file is automatically processed by a conversion program in the Icarus module 42 to convert the data in the document/file to a file of corresponding frequency segments. While a variety of different frequencies and/or frequency ranges may be used, the Icarus module 42 preferably converts the document/file to audio signals. For example, the module 42 can cause the processor 22 to convert the data using a .wav conversion program that equates data characters (letters, numbers, or other symbols) to corresponding audio frequencies. Referring also to FIG. 7, a look-up table (LUT) 120 stored in the disk drive(s) 26 (or possibly the memory 24) provides relationships between characters 122 (e.g., the 256 standard ASCII characters) and corresponding audio frequencies 124. Each character is converted to a segment of a corresponding frequency and of a length of about 1 ms. The lengths of the segments 124 depend upon an amount of data to be encoded and sent. The frequency segments are concatenated to form a sequence of frequency segments. The converted data are thus an audio file of a string of frequencies corresponding to the characters comprising the data.

At stage 104, the Icarus module 42 alters the frequencies of the converted data (here, the pitch of an audio file) produced by the conversion program. The pitch may be altered in several ways, e.g., by removing portions of the frequency segments using software (e.g., removing every second byte of digital information forming a frequency segment), by modifying the sound using hardware, etc. Preferably, the sound is altered in hardware by passing the audio file through the media controller 26 such as Microsoft's Media Control Interface (MCI). The media controller 26 increases the pitch of the audio signals in the audio file. The media controller 26 universally increases the frequencies in the audio file by a factor defined in the process code, typically between about 10 and about 20.

At stage 106, an inquiry is made as to whether the audio file can be further pitch increased. If so, then the process 100 returns to stage 104 for further pitch increasing such that the audio file is repeatedly run through the media controller 26 to increase the pitch as desired (e.g., a fixed number of passes through the media controller 26, until a fixed multiplier has been reached such as a 200,000 times increase in pitch, until a desired file size is reached, etc.). In this example, if the size of the audio file has reached its limit (e.g., between about 0.4 seconds and about 0.5 seconds for a non-streaming file, or about 1 second for a streaming file due to, e.g., error limits), then the pitch is not increased further and the process 100 proceeds to stage 108.

At stage 108, the pitch-altered audio file is stored for transfer and transmitted. The high-pitch audio file is written to a transfer file by the Icarus module 42. The high-pitch audio file is stored as a .wav file in the memory 24 for transmission to the network 14. The user's processor 22 can send the contents of the high-pitch file over the communication network 14 in a streaming or standard packet manner. The data are received by a recipient's computer, which for example is configured similarly to the computer terminal 12 from which the high-pitch audio file is sent. Thus, for exemplary purposes, it is assumed that the file is received by the terminal 12.

At stage 110, the received data are read and down-converted in pitch. If the incoming audio file is streamed into the receiving terminal 12, then the file is sent to the speaker(s) 34 to be played and the produced audio is recorded by the terminal 12 (e.g., by a Microsoft MCI). If the file is not streamed, then the file is stored in the memory 24. The receiver's computer 12 feeds stored the high-pitch file into the media controller 26 to slow the pitch of the frequency segments, preferably by the same incremental amount by which the media controller 26 in the sending device increased the pitch of the frequency segments. Alternatively, the pitch may be slowed by introducing information into the file using software (e.g., to reverse a software-induced increase in pitch).

At stage 112, an inquiry is made as to whether the frequencies of the segments of the audio file have been decreased in pitch to normal pitch (pre-converted). This inquiry can take several forms. For example, the receiving terminal 12 may be informed (e.g., as part of the information received from the network 14, or by user input, etc.) as to the number of times that the pitch needs to be decreased by the media controller 26, or the magnitude of the desired reduction in pitch (e.g., 200,000 times). Alternatively, the audio file may be analyzed to determine if the pitch of the frequency segments puts the frequencies in the audible range, or if the frequencies correspond to expected frequencies, such as those in the LUT 120. If the frequencies have not been desirably reduced in pitch, then the process 100 returns to stage 110 for further pitch decreasing such that the audio file is repeatedly run through the media controller 26 to decrease the pitch as desired. If the file's pitch has been desirably reduced (preferably exactly reversing, or nearly so, the increase in pitch performed by the sending device), then the audio file is now a normal-pitch file, the pitch is not decreased further and the process 100 proceeds to stage 114.

At stage 114, the normal-pitch file is converted from audio format to data format. Here, the receiver's computer 12 applies a decoding opposite to the .wav encoding performed by the sender's computer (here, also the terminal 12). The receiver's computer 12 converts the audio frequencies to data characters in accordance with the same mapping (e.g., the LUT 120) used by the sender's computer 12 to convert data characters to frequencies. The converted data characters form the data file that was originally at the sender's computer 12.

The process 100 as described above is exemplary and not limiting. For example, the sending and receiving computers will typically not be one and the same computer, although this is possible and was used as an example above for simplicity. Further, while the Icarus module 42 was described as being configured to encode the data, including compressing the data (e.g., increasing the pitch of the frequency segments), and decode the data, including decompressing the data (e.g., reducing the pitch of the received frequency segments), other embodiments of the Icarus module 42 may be used. For example, embodiments of the Icarus module 42 may be configured to encode only, decode only, compress only, decompress only, encode and compress only, decompress and decode only, etc.

DivAO

Referring again to FIGS. 1-2, the server 16 includes a compression module 90 and the computer terminal 12, in its memory 24, includes the compression module 50. The compression module 50 may be configured to act like the compression module 90 if the computer terminal 12 acts as a server as well as a user computer terminal. Similarly, the compression module 90 may be configured with features and functions of the compression module 50 if the server 16 will receive as well as transmit information such as web pages. The compression module 90 is configured to search HTML and/or XML files and replace common markup tags in such files with shorter, uncommon characters to help reduce the file size, e.g., of web pages. For example, the compression module 90 is configured to cause a processor of the server 16 to search for common tags such as HTML, head, body, title, HREF, etc. tags that are found in most web files. The compression module 90 is further configured to replace such common tags with corresponding shorter, uncommon characters. Thus, the compression module 90 can replace longer, e.g., 6-byte tags, with characters occupying less memory, e.g., 2 bytes each. The common tags may be replaced by the compression module 90 with uncommon characters such as \acute{Ø}\check{o}BΦ\check{yz}ΦΨ. The compression module 50 in the computer terminal 12 is configured to reverse the compression applied by the compression module 90. The compression module 50 is configured to search compressed web page files for the uncommon characters and replace the uncommon characters with their corresponding tags (e.g., HTML or XML tags).

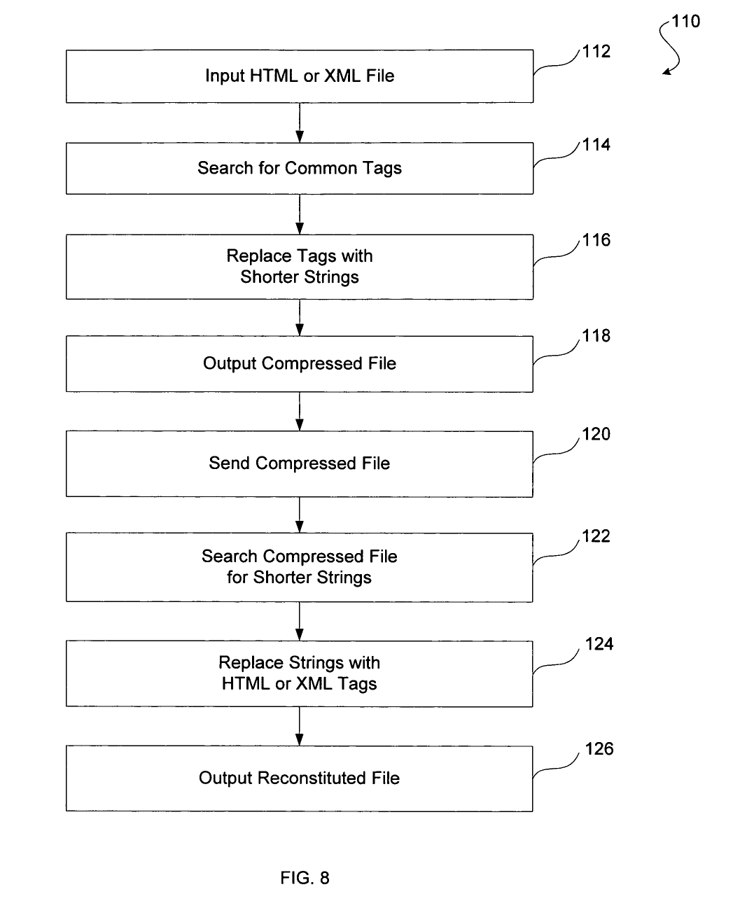

In operation, referring to FIG. 8, with further reference to FIGS. 1-2, a process 110 for compressing, sending, and de-compressing files using the compression modules 90 and 50 includes the stages shown. The process 110 however, is exemplary only and not limiting. The process 110 may be altered, e.g., by having stages added, removed, or rearranged.

At stage 112, the compression module 90 of the server 16 is provided with an HTML or XML file for compression. The file may be provided by being identified to the compression module 90 by, for example, being selected by a user of the computer terminal 12 as indicated by a request received by the server 16. The file may be identified by being stored in memory of the server 16.

At stage 114, the identified file is searched for common tags. Here, the compression module 90 causes a processor of the server 16 to search the identified file for common tags that are frequently found in HTML or XML files. For example, the compression module 90 instructs searching of the identified file for HTML, head, body, title, HREF, etc. tags.

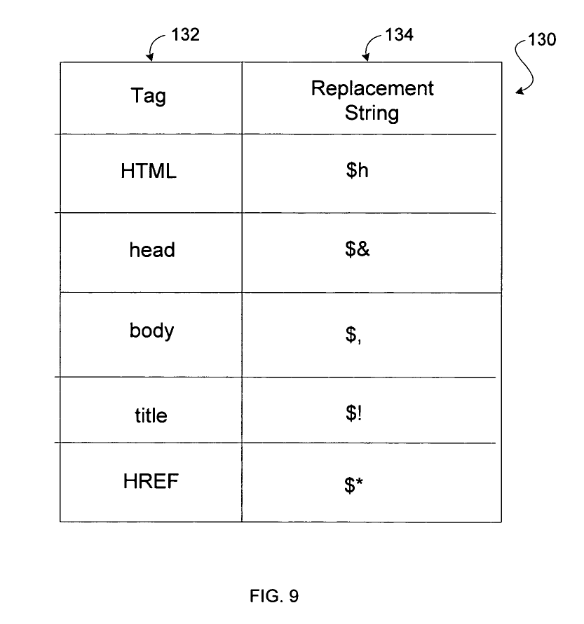

At stage 116, the found tags are replaced by shorter strings of information. Here, for example, the compression module 90 causes the processor of the server 16 to replace found common tags 132 with corresponding shorter, here 2-byte character strings 134, as shown in a look-up table 130 shown in FIG. 9. Thus, for example, the HTML tag is replaced by a character string $h, the head tag is replaced by a character string &#, etc.

At stage 118, the compressed file is output by the compression module 90. The compressed file with the replaced tags 132, being replaced by the shorter character strings 134, is stored for transmission.

At stage 120, the compressed file is sent to the computer terminal 12. The compressed file is sent by the server 16 over the network 14, occupying fewer memory slots than would be used had the file not been compressed.

At stage 122, the computer terminal 12 receives the compressed file and searches for the short replacement character strings 134. The compression module 50 causes the processor 22 to search the received compressed file for the replacement character strings 134 as shown in the look-up table 130.

At stage 124, the replacement character strings 134 are replaced by their corresponding HTML or XML tags 132. The compression module 50 causes the processor 22 to substitute the tags 132 corresponding to each of the found replacement strings 134 in the received compressed file.

At stage 126, the reconstituted file is output. The file, having been reconstituted by substitution of the original tags 132 for the replacement character strings 134, is stored in its reconstructed form. The reconstructed file may be used by the computer terminal 12, for example by displaying a corresponding web page on the display 28.

The encoding and decoding described above with respect to FIGS. 8-9 is exemplary only and not limiting of the invention. Different techniques for encoding and decoding web pages, for example, by replacing common tags with characters other than those shown, may be used.

Pandora Web Browser

Referring again to FIGS. 1-2, the web browser module 44 provides a web browser inside of a header file. The header file contains information received from a server when a download request and resembles:

HB@REDHAT6˜] $TELNET SLACK 80

CONNECTED TO 192.343.434

GET/INDEX.HTML

<HEAD> <TITLE> SOME DATA TITLE </TITLE> <HEAD>

<NOSCRIPT> SOME TEXT </NOSCRIPT>

The web browser is preferably a complete web browser comprising a RichEdit control (a common ActiveX control for writing documents, primarily for Word®, whose core HTML decoding functions are based on a header algorithm). This header algorithm is preferably a completely independent web browser that makes its Internet requests without using Microsoft's Internet Explorer®. The header algorithm is configured to convert HTML code into RichEdit format. This RichEdit control provides for significantly greater control than using Microsoft Explorer including providing essentially total control over all data that passes through the browser. The header algorithm is configured to set up a socket for downloading data such as web pages and to reproduce text and images close to if not the same as those in the HTML format.

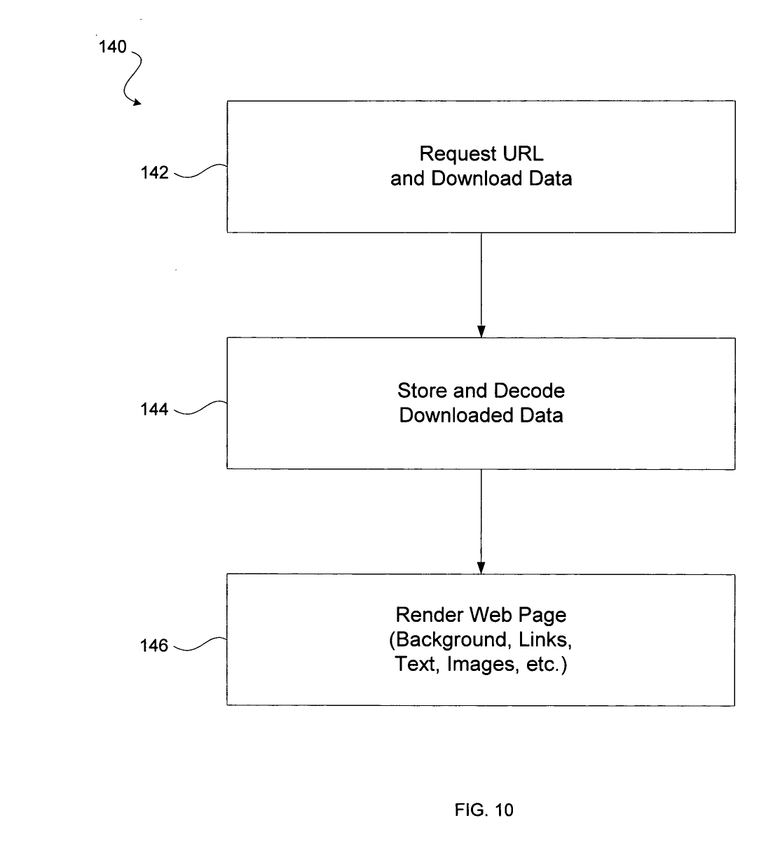

In operation, in referring to FIG. 10, with further reference to FIGS. 1-2, a process 144 for requesting and downloading web pages using the web browser 44 includes the stages shown. To process 140, however, is exemplary only and not limiting. The process 140 may be altered, e.g., by having stages added, removed, or rearranged.

At stage 142, a web page is requested and downloaded. The computer terminal 12 requests a URL through a web browser (e.g., through a link) provided by the web browser module 44. The module 44 produces a socket connection to a host server, e.g., the server 18, and obtains the web document from the server 18 through the socket connection. The data from the server 18 representing the desired web page is downloaded through the socket connection to the computer terminal 12.

At stage 144, the downloaded data from the server 18 are stored and decoded by the web browser 44. The received file is written to memory (e.g., a disk in the memory 24) for decoding by the module 44. The module 44 includes a decoding section that is configured to decode the stored, downloaded data by recognizing HTML tags and stylesheets and converting lines of java script coding into Rich Text Format (RTF) that can be read by the RichEdit control.

At stage 146, the downloaded and decoded webpage is rendered by the web browser 44. The RichEdit control renders the web page by getting the page's background color, setting the RichEdit control's color to be near (preferably as near as possible) to this color. The module 44 also converts links in the HTML page to blue underlined and selectable (e.g., clickable) text and other text to a font and style formatted text that resembles the original text, preferably as much as possible. The RichEdit control also preferably renders images by streaming the images into a buffer in the memory 24 and loading the images from the memory 24 using external JPEG and GIF headers.

Xure

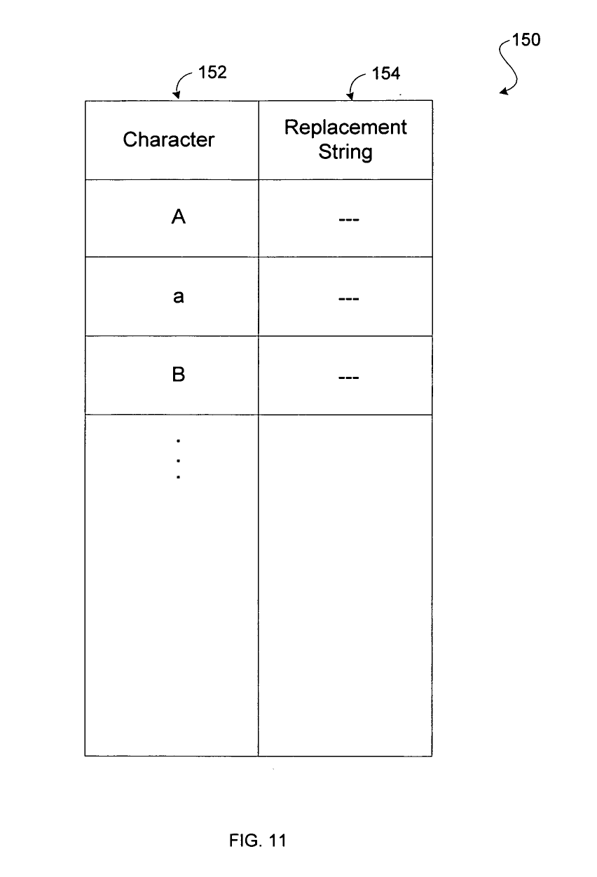

The encryption module 46 is configured to replace characters in a file of data such that each character in the file is replaced with approximately 10,800 characters. The encryption module 46 utilizes a string replace function in C++ builder that replaces letters in a given piece of text or other collection of data with a 600-letter string. This string is computationally multiplied, pi formatted, added to a symbol-based string and is multiplied out again. The encryption module 46 is configured to replace each character in the file of data with a corresponding 600-letter string in accordance with a conversion table 150 shown in FIG. 11. The conversion table 150 shown in FIG. 11 indicates that for each character of the standard 256 ASCII character set, a corresponding, unique, 600-character string is associated with that character. For each ASCII character 152, the module 46 will replace that character with its corresponding replacement string 154.

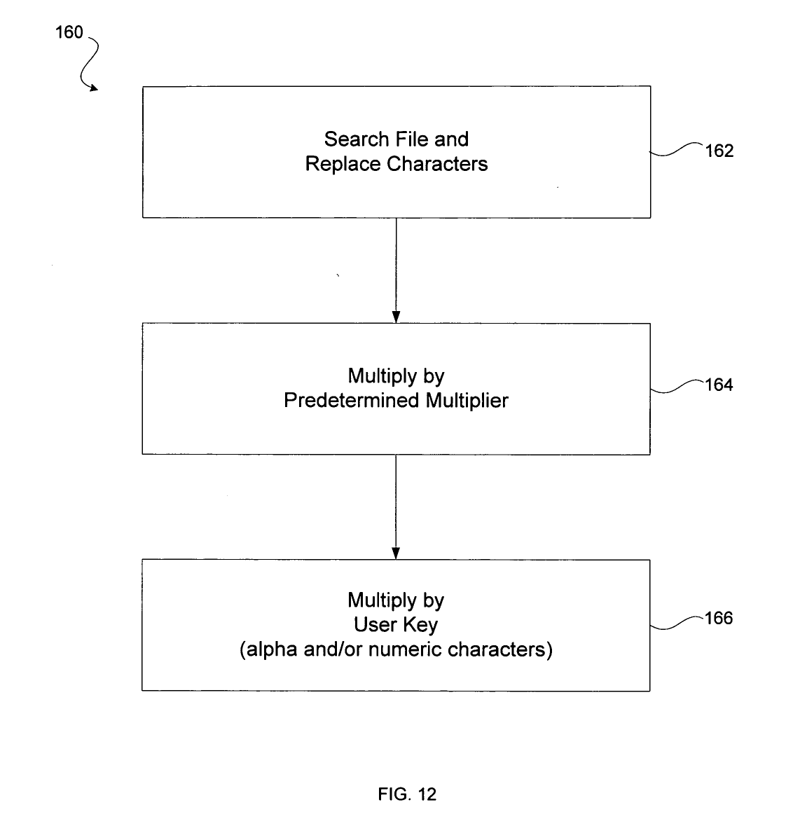

In operation referring to FIG. 12, with further reference to FIGS. 1-2 and 11, a process 164 for encrypting a file of data using the encryption module 46 includes the stages shown. The process 160, however, is exemplary only and not limiting. The process 160 may be altered, e.g., by having stages added, removed, or rearranged.

At stage 162, a file of data has its characters replaced with pre-determined strings of characters. The encryption module 46 instructs the processor 22 to step through the characters in the file of data. For each character in the file, the processor 22 finds this character 152 in the table 150 and replaces the character 152 with the corresponding replacement string 154 as shown in the replacement table 150.

At stage 164, the replacement strings 154 are multiplied by a pre-determined multiplier. The replacement strings 154 are represented as numbers in binary fashion. The processor, under instructions of the encryption module 46, multiplies the 600-character strings in numeric format by a pre-determined number such as pi taken to six decimal places.

At stage 166, the encryption module 46 causes the processor 22 to multiply the pi-formatted strings of data by a user key. The user key is a numerical representation of information such as a set of characters, numbers, or alpha-numeric characters, e.g., entered by a user of the computer terminal, e.g., through the keyboard or through the mouse 32. The user key is preferably substantially unique, being of a length and/or complexity such that the user key, while theoretically possible to duplicate, is difficult to reproduce such that decrypting the information encrypted with the user key is correspondingly difficult.

It is possible that, as an option, the encrypted text can be sent to a receiving computer terminal and decrypted by that terminal. The encryption module 46 preferably includes software instructions for decrypting files encrypted by the process 160. The encryption module 46 can divide characters of incoming data files by the user key, and by the pre-determined multiplier such as pi taken to 6 decimal places. The encryption module 46 can further substitute the determined replacement strings 154 with their corresponding ASCII characters 152 according to the table 150. The original file may thus be reconstituted.

Registry Updates.

The registry update module 48 provides a system registry for instructing the hardware of the computer terminal 12 how to work. The registry update module 48 operates through the configuration (config.) files to modify the system hardware to allow for more than the default number of sockets to be used for data transfer. This default number may be set by the manufacturer, e.g., Microsoft®. These registry updates alter the way that the operating system can send and receive files to and from the network 14. The updates comprise MaxConnection updates as well as user configurable and registry changes (e.g., Utility 3, Hypemet, etc.). The registry updates may be configured to automatically take effect upon boot up of the system 12, or may be provided in other ways, for example, through a selectable icon on the display 28 that can be selected in order to cause a modification of the files to include the registry updates that will take effect upon rebooting of the computer terminal 12.

DVD Player

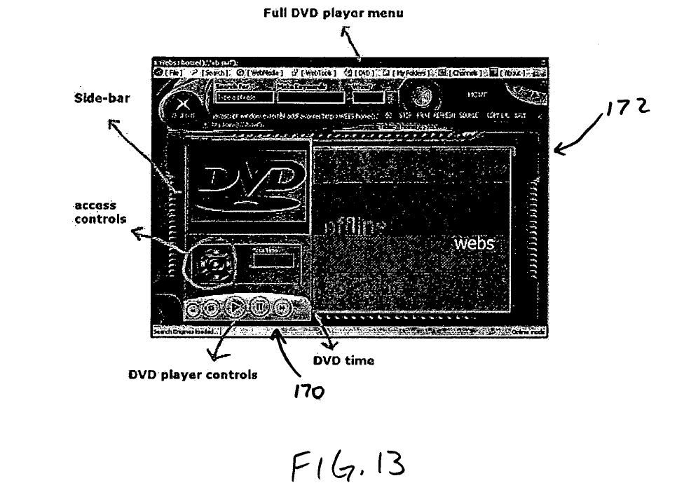

Referring to FIGS. 1-2 and 13, the memory 24 may also include a DVD player submodule in the web browser module 44 for providing a DVD viewable screen 170 within the web browser display 170. Thus, a web browser screen can include ongoing video from a DVD as well as other visual information such as web pages. The user of the terminal 12 can therefore view a DVD movie without having to open separate web browser and DVD screens. The DVD screen 170 and the remaining portion of the web browser screen 172 can be configured to be used together, assisting the user to use the web browser while simultaneously watching the DVD movie in a visual format specifically designed for this versus having the user attempt to size and arrange separate DVD and web browser screens.

Other embodiments are within the scope and spirit of the disclosure and the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. Also for example, the Hyperspeed technique can be implemented in various ways, e.g., without using the broadband servers 58 discussed above.

As used in this disclosure, the term data may refer to digital and/or analog information. Further, audio as used herein (in particular in the Icarus portion) may refer to any human or machine-audible sound, music, or audio type including compressed audio files, raw audio files, ncompressed audio files, audio data of any machine-readable or software-decodable type, software readable audio data, MIDI data (which can be used as an alternative to audio conversion from raw data where the inital data can be reproduced from software or machine code, where the standard system data form (txt,zip,etc.) has been converted into a MIDI type file), hidden audio data, streamed audio data, audio data which has been encapsulated as part of a video file or otherwise implanted as a readable part of another data type.

Exemplary Code

Exemplary portions of software code for implementing various functions are provided here. The portions of code are exemplary only, and not limiting, as other specific code and/or other techniques may be used to implement the principles described in the disclosure here.

Hyperspeed Xsocket

The description above regarding the Hyperspeed module 40 discussed using INET controls. Other techniques are possible, including using a technique implemented by the following code.

------------------------------------------------------------------------------------------------------------
BEGIN CODE : XSOCKET
------------------------------------------------------------------------------------------------------------
/***********************************************************************

| | | |
|---|---|---|
| ** | ® Adnan Osmani 2003/2004 | ** |
| ** | The code below specifies the feature: XSOCKET, which may | ** |
| ** | be used as a compiled or inclusive module in the XWEBS app. | ** |
| ** | This header file provides capabilities similar to the INET | ** |
| ** | ActiveX control , and may be used as a copyrighted alternative. | ** |

***********************************************************************//
#include <iostream.h>
#include <winsock.h>
#include <stdlib.h>
#include <stdio.h>
#define FAST_fastcall
#define XW_DEF_PORT -1 //port used
// initilize and terminate_winsock
void initwinsock( );
void terminate_winsock( );
// structure to automaticly initlize and terminate_winsock
struct AutoWinSockHandle
{

inline AutoWinSockHandle( )
{

initwinsock( );

}
inline ˜AutoWinSockHandle( )
{

terminate_winsock( );

}

};

| static AutoWinSockHandle sock_handle; | | // automatically construct, and deconstruct |
|---|---|---|
| | | // winsock with this structure |
| struct XWebsSocket | | |
| { | | |
| | SOCKET socketx; | // the socket structure |
| | HWND hwnd; | // handle of the window attached |
| | UINT SOCKET_ID; | // socket ID |
| | void CreateSocket(HWND hwndx,UINT SOCKET_IDx); | // create the socket |
| | void Listen(UINT port); | // listen on the socket |
| | void Connect(char* ipaddress,UINT port); | // connect with the socket |
| | void Send(char* buff, int len); | // send data with a connected socket |
| | int Recive(char* buff,int len); | // receive data |
| | void Accept( ); | // accept a incoming socket |
| | const UINT GetID( ); | // get the ID of this socket |
| | void Close( ); | // close the socket |

};
// initilze windows sockets
void initwinsock( )
{
WORD wVersionRequested;
WSADATA wsaData;
int err;
wVersionRequested = MAKEWORD( 1, 1 );
err = WSAStartup( wVersionRequested, &wsaData );
if ( err != 0 ) {

MessageBox(0,“Error 305: Unable to init WinSock!”,“Aborting”,

MB_ICONINFORMATION);

PostQuitMessage(0);

return;
}
if ( LOBYTE( wsaData.wVersion ) != 1 ||

HIBYTE( wsaData.wVersion ) != 1 ) {

```
  WSACleanup( );
  return;
}
}
// terminate_winsock, on lcose
void terminate_winsock( )
{
```

WSACleanup( );

}
// the XWebs socket data structure
void XWebsSocket::CreateSocket(HWND hwndx, UINT SOCKET_IDx)
{

hwnd = hwndx;
SOCKET_ID = SOCKET_IDx;
socketx = socket(AF_INET,SOCK_STREAM,0);
WSAAsyncSelect(socketx,hwnd,SOCKET_ID,FD_CONNECT|FD_READ|FD_C

LOSE|FD_ACCEPT);
}
// begin listening
void XWebsSocket::Listen(UINT port)
{

if(port == XW_DEF_PORT) { port = 81; }

struct sockaddr_in addy;

addy.sin_family = AF_INET;
addy.sin_port = htons(port);
addy.sin_addr.s_addr = INADDR_ANY; //an IP address
bind(socketx,(struct sockaddr*)&addy,sizeof(addy));
listen(socketx,5);

}
// connect to a remote socket
void XWebsSocket::Connect(char* ipaddress,UINT port)
{

struct sockaddr_in addy2;
if(port == XW_DEF_PORT) { port = 81; }//allow port definition to HTTP port:81
addy2.sin_family = AF_INET;
addy2.sin_port = htons(port);
addy2.sin_addr.s_addr = inet_addr(ipaddress);
connect(socketx,(struct sockaddr*)&addy2,sizeof(addy2));

}
// accept a request from remote socket
void XWebsSocket::Accept( )
{

struct sockaddr cli_addr;

int clilen;

clilen = sizeof(cli_addr);
socketx = accept(socketx,(struct sockaddr*)&cli_addr,&clilen);

}
// send data once socket is connected
void XWebsSocket::Send(char* buff, int len)
{

send(socketx,buff,len,0);

}
// recive data from a connected socket
int XWebsSocket::Recive(char* buff,int len)
{

return recv(socketx,buff,len,0);

}
// get the ID of a given socket, for the wndproc callback
const UINT XWebsSocket::GetID( )
{

return (const UINT)SOCKET_ID;

}
// close an open socket
void XWebsSocket::Close( )
{

closesocket(socketx);
}
------------------------------------------------------------------------------------------------------------
END CODE
------------------------------------------------------------------------------------------------------------

1. An apparatus for retrieving information via a communication network, the apparatus being configured to:
analyze a first request for a collection of information;
produce a set of second requests for a corresponding set of portions of the collection of information, each of the set of second requests being associated with a separate communication socket;
store received segments of data associated with each of the communication sockets such that segments of data corresponding to a particular socket are stored in association with other of the received segments of data; and
reconstitute the collection of information from the stored segments of data.

2. The apparatus of claim 1 wherein the communication network includes servers and the second requests are configured to be sent to different servers in the communication network.

3. The apparatus of claim 1 wherein the first request is for a web page, and the second requests cause the servers to obtain data from a web server storing the web page with a higher priority than other web page requests to the web server.

4. The apparatus of claim 3 wherein the requests are one of NET control commands and Xsocket commands.

5. The apparatus of claim 1 wherein the set of second requests is configured to request downloading a web page and at least some of the second requests are associated with sockets typically used for data communication other than downloading web pages.

6. The apparatus of claim 1 wherein the apparatus is further configured to produce a file for storing the segments of data.

7. The apparatus of claim 6 wherein the apparatus is configured to store the received segments of data in separate portions of the file in accordance with the sockets with which the segments of data are associated.

8. The apparatus of claim 1 wherein the apparatus is further configured to establish LAN connection with a server in the computer network from which to receive the segments of data.

9. The apparatus of claim 1 wherein the apparatus comprises a computer program product residing on a computer readable medium and including computer-readable instructions for causing a computer to analyze the first request, produce the set of second requests, stored received data segments, and reconstitute the collection of information.

10. The apparatus of claim 1 further configured to effect registry updates to alter designated purposes of communication sockets.

11. The apparatus of claim 1 wherein the collection of information is a web page in one of HTML and XML format, the apparatus being further configured to replace at least one uncommon character string in the reconstituted web page with a corresponding HTML or XML tag.

12. The apparatus of claim 11 wherein each of the uncommon character string comprises less data than the corresponding HTML or XML tag.

13. The apparatus of claim 11 wherein at least one of the at least one uncommon character string is a single character.

14. A time-division-multiplexed data structure comprising:
a plurality of data slots for containing data;
wherein the data slots are designated for containing data in accordance with a standard protocol for communicating with a computer terminal through a serial port of the computer terminal; and
wherein at least one of the data slots that, according to the protocol, should contain data, if any, for information other than a web page, is populated with data of a web page.

15. The data structure of claim 14 wherein multiple data slots that, according to the protocol, should contain data, if any, for information other than a web page, are populated with data of a web page.

16. The data structure of claim 15 wherein the web page is divided into divisions equal in number to a quantity of the multiple data slots, and wherein the multiple data slots are each populated with data from a corresponding one of the divisions of the web page.

17. The data structure of claim 15 wherein a majority of data slots of the data structure are designated for containing data in accordance with the standard protocol.

18. The data structure of claim 15 wherein a quantity of the multiple data slots is between two and seven, inclusive.

19. A device for encoding non-audio data into compressed audio data, the device being configured to:
replace portions of the non-audio data with audio segments such that portions of the non-audio data that are different will be replaced with different frequencies of audio segments; and
increase at least one pitch of the audio segments.

20. The device of claim 19 wherein the device is configured to increase the at least one pitch using hardware.

21. The device of claim 20 wherein the hardware is a Microsoft® media control interface.

22. The device of claim 19 wherein the device is configured to increase the at least one pitch using software to remove portions of information forming the audio segments.

23. The device of claim 19 wherein the device is configured to increase the at least one pitch for all of the audio segments by a common amount.

24. The device of claim 19 configured to increase the at least one pitch of the audio segments multiple times.

25. The device of claim 24 configured to increase the at least one pitch of the audio segments until a limit is reached.

26. The device of claim 25 wherein the limit is a file size such that the audio segments form a file with a duration between about 0.4 seconds and about 0.5 seconds.

27. The device of claim 19 wherein lengths of the audio segments are dependent upon an amount of the non-audio data.

28. The device of claim 19 wherein the portions of the non-audio data are characters and wherein each unique character has an associated unique audio segment frequency.

29. The device of claim 19 further configured to send the audio segments with increased pitch to a communication network.

30. The device of claim 29 wherein the device is configured to stream the audio segments with increased pitch to the communication network.

31. The device of claim 19 wherein the device comprises a computer program product residing on a computer readable medium and including computer-readable instructions for causing a computer to replace the non-audio data with audio segments and to increase the at least one pitch of the audio segments.

32. A device for decoding compressed audio data into non-audio data, the device being configured to:
decrease at least one pitch of received, pitch-elevated audio segments to convert the pitch-elevated audio segments into desired-pitch audio segments; and
replace the desired-pitch audio segments with associated non-audio data portions such that desired-pitch audio segments of different frequencies will be replaced with different non-audio data portions.

33. The device of claim 32 wherein the device is configured to decrease the at least one pitch using hardware.

34. The device of claim 33 wherein the hardware is a Microsoft® media control interface.

35. The device of claim 32 wherein the device is configured to decrease the at least one pitch using software to add portions of information to the audio segments.

36. The device of claim 32 configured to decrease the at least one pitch of the audio segments multiple times.

37. The device of claim 36 configured to decrease the at least one pitch of the audio segments until the audio segments have at least one desired pitch.

38. The device of claim 32 wherein the portions of the non-audio data are characters and wherein each unique character has an associated unique audio segment frequency.

39. The device of claim 32 further configured to receive the pitch-elevated audio segments from a communication network.

40. The device of claim 39 wherein the device is configured receive the pitch-elevated audio segments from the communication network in a streaming format.

41. The device of claim 40 further configured to have the streaming pitch-elevated audio segments played by speakers and recorded before the at least one pitch is decreased.

42. The device of claim 32 wherein the device comprises a computer program product residing on a computer readable medium and including computer-readable instructions for causing a computer to decrease the at least one pitch of received, pitch-elevated audio segments and to replace the desired-pitch audio segments with associated non-audio data portions.

43. A computer program product residing on a computer readable medium and comprising computer-readable instructions for causing a computer to:
produce a socket connection to a communication network;
send web page requests toward the communication network; and
convert HTML web page data received from the communication network into RichEdit format.

44. The computer program product of claim 43 wherein the computer-readable instructions comprise a RichEdit control.

45. The computer program product of claim 43 wherein the computer-readable instructions are contained in a header file.

46. The computer program product of claim 43 wherein the computer program product resides in a computer that contains Microsoft® Internet Explorer and wherein the web page requests are sent independent of Microsoft® Internet Explorer.

47. The computer program product of claim 43 wherein the HTML web page data are converted by setting a RichEdit control color to at least approximate a background color of a received HTML web page, converting HTML links to blue, underlined, selectable text, and converting other text to a font and style that at least approximates the text font and style of the HTML page.

48. The computer program product of claim 43 wherein the HTML web page data are converted by streaming images in the HTML web page into a buffer and loading them using at least one of jpeg and gif headers.

49. A method of encrypting data, the method comprising:
replacing characters in a data set with corresponding strings of data, a different character string corresponding to each different character;
multiplying the strings of data by a predetermined common multiplier; and
multiplying the strings of data by a user multiplier;
wherein the user multiplier is provided by a user such that a product of the strings of data, the common multiplier, and the user multiplier is substantially unique to the user.

50. The method of claim 49 wherein the corresponding strings of data are 600-character strings unique to each character in a set of characters.

51. The method of claim 49 wherein the common multiplier is a concatenated portion of pi.

52. The method of claim 51 wherein the common multiplier is pi taken to six decimal places.

53. The method of claim 49 wherein the user multiplier is entered into a computer by the user through at least one of a keyboard and a mouse.
